(19) United States
(12) Patent Application Publication
(10) Pub. No.: US 2010/0049693 A1
(43) Pub. Date: Feb. 25, 2010

(54) SYSTEM AND METHOD OF CACHE BASED XML PUBLISH/SUBSCRIBE

(75) Inventors: Yang CAO, Ottawa (CA); Shikharesh Majumdar, Ottawa (CN); Chung-Horng Lung, Kanata (CN)

Correspondence Address: Kramer & Amado, P.C., 1725 Duke Street, Suite 240, Alexandria, VA, 22314, US

(73) Assignee: Alcatel-Lucent, Paris (FR)

(21) Appl. No.: 12/197,802

(22) Filed: Aug. 25, 2008

(51) Int. Cl. G06F 7/10; G06F 17/30

(52) U.S. Cl. 707/2; 707/E17.017

(57) ABSTRACT

A publish/subscribe content-based distribution of messages, receives a message, codes the message to generate a message identifier, content filters the message to identify matches to subscription queries, retrievably caches the matches based on the message identifier, receiving another message, codes the message to generate its message identifier, accesses the cache with the message to identify any associated previously identified query match and, if not identified, content filters the message and, conditional on matches to subscription queries, reports the message and updates the cache.

### TECHNICAL FIELD

Embodiments relate generally to publish/subscribe systems, for example to publish/subscribe systems based on Extensible Markup Language (XML) annotation.

### BACKGROUND

An enormous quantity of new information is being generated every day, from a growing universe of sources, and streaming through various portals into and over the Internet. Just a small sampling from the growing universe of sources shows, for example, news organizations, government information sources, corporate advertising organizations, political organizations, financial reporting entities and countless blog postings.

The potential value of the information that lies within the millions and millions of streaming messages, though, can only be realized and exploited if that information is efficiently and reliably directed to the various persons interested in its various and many items, topics and species.

Certain kinds and items of the information within this increasingly large number of messages from an increasing number of sources often have a very high time value, especially to persons in and associated with various and particular professions and business operations.

Often, to such persons and business operations, a failure to quickly obtain specific, desired kinds and items of information or, worse, a failure to ever receive the information, may be very costly.

The quantity and range of this information, however have become so large, both in terms of its rate and the number of sources from which it originates, that persons, even those having a very high interest in quickly obtaining information, cannot possibly monitor each of the myriad of sources and messages in which the information may be found.

One method directed to partially reducing this problem is the “publish/subscribe” system. Publish/subscribe systems function as a set of parallel filters, scanning streaming messages, e.g., millions, each filter configured for a particular content type or item of information. Typically, the filters are constructed from queries received from particular interested persons or entities, called “subscribers” who describe the type of information that she/he is interested in. When the item or type of information is identified by the filter, the arrangement sends the message, or snippets of such messages, to the subscriber(s) associated with the filter.

Various implementations of publish/subscribe systems are known. Each has various kinds of costs and limitations.

One very simple implementation, which is not universally referred to as a “publish/subscribe,” is RSS. RSS syndicates web-posted information from sources such as, for example, news and news-like sites, news-oriented community sites such as, for example, Salon™, Slashdot and personal weblogs.

RSS is generally viewed as a push-pull arrangement. Notice of changes on the selected sites is pushed to the user and the user, in response, may initiate an action to pull the new information.

In a typical RSS arrangement, recipient users configure an aggregator to establish links to each of a selected plurality of the site-generated feeds. The RSS recipient typically configures another RSS application to check the selected feeds for changes, and to react in a particular manner. The reaction may, for example, be sending an e-mail address chosen by the recipient, the e-mail message having a link to the web-site page identified by the feed. Another example reaction is automatically inserting the link in the recipient's blog site.

RSS systems, however, require the user to identify each of the site feeds, and require each of the sites that generate feeds to configure the generation to meet various, often conflicting objectives of distributing information. As known in the RSS arts, due to human limitations the number of feeds is necessarily a very, very small subset of the universe of generated site feeds.

Further, in RSS, human judgment is required as to which message or posting to pull, which introduces a probability that valuable information will, in fact, be missed or overlooked by the user.

To address certain of these limitations of conventional RSS systems, another publish/subscribe system uses a push-type arrangement, in which users generate queries, which are formatted into “subscriptions” that include the query and the user identifications. The queries may, for example, be Boolean expressions. Various content filters are constructed according to the subscriptions.

The subscriptions, and the content filters reside on an intermediary application or resource, which may be termed a “broker.”

The broker typically includes a message receiving resource, such as an Internet access application, configured to receive messages from a plurality of sources, typically referenced as “publishers.” The broker receives queries from various subscribers, forms these into “subscriptions,” constructs a content filter or filters representing all of the subscriptions, and applies these content filters to each to the received messages. When a match or hit is identified, the message, or a part of the message having the match is sent to the subscriber.

Present publish/subscribe systems with subscription-based filtering for content, however, have considerable processing overhead. A fundamental reason for the overhead is that content filter processing, of the type needed to adequately and specifically identify the information meeting the various subscriptions, which may be disbursed about or somewhat hidden in lengthy messages, has a high computational burden.

For example, in a typical publish/subscribe arrangement, the messages from the publishers to the brokers may be in Extensible Markup Language (XML) format. Content filters for XML may of course be constructed, by converting the subscriptions to XPath queries, from which a specific filter application, or set of filter applications may be constructed. Various kinds and examples of such XPath based filters are well-known in the art. According to the known XPath and equivalent function XML query filters, including streaming XML message filters, that are known to persons skilled in the XML arts, querying arts, prior to actual filtering for content the received XML message parsed into a sequence of XML node “events” and then a tree must be constructed from the sequence of XML node events. Various methods for such parsing and tree construction are well known.

The parsing, tree construction, and XPath-based filter application, which is performed upon each receipt of a message, from any of the publishers, is very computationally intensive.

The computational burden is increasing as the allowable range and complexity of the queries increases. The cost manifests as hardware cost, system performance reduction, e.g., the number of subscriptions that can be maintained, the rate of messages and the maximum length of messages that can be content filtered.

Exacerbating this considerable processing overhead, and the associated costs of present publish/subscribe systems, is the frequent instances of duplicate receipts by a broker of the same message. Causes of the duplicate receipts are, for example, the asynchronous transmission, routing, distribution of the messages during the repeated receive-and-forward routing iterations through the various, different and changing routers and other network nodes between the publishers and the brokers.

Regardless of having previously received a message, and having previously parsed the same message and applied all content filters embodying all subscriptions maintained by the broker to the message, upon receiving the duplicate the broker repeats the same significant expenditure of resources, to again obtain the same subscription matches.

### SUMMARY

Embodiments provide subscription-based content filtering, selection and forwarding of received publisher-generated messages, with substantial reduction or elimination of repeated content filtering, and associated wasting of computing resources, on received duplicates of publisher-generated messages.

Various embodiments a publish/subscribe method for content-based distribution of messages generated by publishers, in accordance with given content-based filters based on given subscriptions based on given queries, comprising forming a cache of query match records, each record associated with a respective message, and record each stored to be retrievable based on a coding of the message; receiving a new message; coding the new message to generate message identifier code; identifying, based on accessing the cache with the message identifier code, whether the cache has a query match record for the new message; and conditionally performing a content filtering operation, based on a result of said identifying, said conditionally performing including, if said identifying identifies the cache as having not having a subscription record for the new message, content filtering the message to generate query match data identifying queries, if any, satisfied by the message, else content filtering the message.

According to various embodiments the conditionally performing a content filtering operation includes conditionally updating the cache based on the generated query match data.

an externally generated message having content meeting at least one given subscription; calculating a message identifier for the message, based on applying a given calculation rule; content filtering the message, the content filtering based on given subscriptions, to generate a subscription match set identifying each of the given subscriptions the message meets; storing in a cache a subscription match record identifying the subscription match set, the storing being retrievable based on the message's calculated message identifier; receiving a subsequent externally generated message; calculating a message identifier for the subsequent message, based on applying the given calculation rule to the subsequent message; determining whether a cache hit condition is met based on accessing the cache based on the subsequent message's calculated message identifier to determine whether the cache has a valid subscription match record stored based on the subsequent message's calculated message identifier; in response to the cache hit condition being not met, content filtering the subsequent message to generate another subscription match set identifying each of the given subscriptions, if any, the subsequent message meets and updating the cache based on the subsequent subscription match set; and, in response to hit condition being met, not performing the content filtering of the subsequent message.

According to various embodiments, the conditionally updating the cache includes, in response to the generated query match data identifying any query matches, retrievably storing a record of the query match data in the cache to be retrievable based on the message identifier of the message, else not storing a record of the query match data in the cache.

In addition, various embodiments include a publish/subscribe content-based distribution of messages, comprising applying a coding function to each of a plurality of messages, to generate a corresponding plurality of message identifier codes, applying a subscription-based content filter, representing at least one given subscription, to the plurality of messages to generate, for at least one of the messages, a subscription match set indentifying the subscriptions the message meets, forming a subscription match record cache storing at least one of the subscription match sets as a subscription match record, each of the subscription match records stored in the cache to be retrievable using the message identifier code of the message producing, by the content filtering, the subscription match set represented by the subscription match record; receiving a new message; applying the coding function to the new message to generate a new message identifier code; accessing the subscription match record cache based on the new message to identify whether a cache hit condition is met, the hit condition being the cache having a subscription match record accessible by the new message code; and, in response to the accessing identifying the hit condition being met, reporting the new message to subscribers based on the subscription match record accessed by the new message identifier and, in response to the accessing identifying the hit condition being not met, applying the subscription-based content filters to the new message and updating the cache based on a result of the applying.

Various embodiments include a subscription-based content filter engine to filter messages input to the engine, to generate a match result set identifying which, if any, of a given set of subscriptions are met by the input message; a match result cache engine to store match result sets generated by the subscription-based content filter engine, the cache engine having a message identifier code engine to calculate an identifier for the messages and the storing being retrievable from the cache using the message identifier code of the filtered message; and a filter conservation control engine, operatively connected to the subscription-based content filter engine and the match result cache engine, to read the match result cache based on the message identifier of a received publish message to identify between a cache hit and a cache miss, the cache hit being the cache having a corresponding match result set and the cache hit being the cache not having a corresponding match result set and, in response to detecting a cache miss, controlling the subscription-based content filters to filter the message and, based on the subscription match set, if any, generated by the filtering, to update the cache to store the subscription match set to be retrievable based on the message identifier.

In various embodiments the messages may be in XML form and the subscription-based content filter engine or step may comprise, or include applying an X-Path content-based filter to the XML messages to generate a subscription match result.

Various embodiments may include, for new messages in non-XML form, a module, application or step of converting the new messages to XML form.

In various embodiments the subscription-based content filter engine or step may include a parser or parsing step to parse new XML messages to generate a sequence of XML events, and an X-Path based filter or filtering step to filter the sequence of XML events to generate the subscription match result.

### BRIEF DESCRIPTION OF THE DRAWINGS

FIG. 1 shows one illustrative example of a system architecture according to various embodiments; and

FIG. 2 shows an illustrative functional flow of one example of one method according to one or more embodiments.

### DESCRIPTION

The following describes exemplary embodiments and features, in reference to illustrative examples, to enable persons of ordinary skill in the arts pertaining to publish/subscribe systems to practice the invention.

However, as will be apparent to persons skilled the relevant arts, upon reading this disclosure, the invention with its various embodiments may be practiced with, or on various alternative arrangements and implementations, readily identified by such persons, that depart from the specific depicted illustrative examples.

Further, to avoid any obscuring of the various novel features and aspects, the following description omits details of the methods and techniques that are known to persons skilled in the relevant arts and from which, upon reading this disclosure, such persons are enabled to select from and apply to practice according to the various embodiments, including detailed description of known methods, algorithms and techniques of XML, and XML parsing and filtering.

Various embodiments and various exemplary features may be described separately but, although these may have various differences, are not necessarily mutually exclusive. For example, a particular feature, function, action or characteristic described in relation to one embodiment may be included in other embodiments.

In the drawings, like numerals and appearing in different drawings, either of the same or different embodiments of the invention, reference functional blocks or system blocks that are, or may be, identical or substantially identical between the different drawings.

Various functions and operations may be graphically depicted or described as one block, or as an arrangement of blocks but, unless otherwise stated or made clear from the context, the number and arrangement of blocks is only a graphical illustration of functions, and is not a limitation on the implementations for performing the functions.

The term “engine,” as used herein, means any data processing machine capable of accepting an input, and processing the input according to definable rules to generate an output. Unless otherwise stated or made clear from the context, the data processing machine implementing the engine may be implemented by, or otherwise practiced on, any implementation of a data processing machine known to persons of ordinary skill in the art including, but not limited to, a general purpose programmable computer, a networked resource of general purpose programmable computers, and a special purpose data processing machine, and any combination thereof.

The term “message,” as used herein, encompasses, but is not limited to, its ordinary and accustomed meaning in the publish/subscribe arts and includes, but is not limited to, any symbolic representation of information which may, or may not be, a string, representing any information extractable by any content-based filter known in the relevant art including, but not limited to, messages in any markup form including, but not limited to, XML.

The term “subscription,” as used herein, encompasses, but is not limited to, its ordinary and accustomed meaning in the publish/subscribe arts and includes, but is not limited to, any query that is in or is capable of being represented in Boolean form, and has information identifying the subscriber generating or associated with the query.

The term “content filter engine,” as used herein, means any engine capable of receiving a message, capable of performing content-based filtering in accordance with given subscriptions, to identify subscriptions, if any, the message meets, and to generate subscription match result identifying content subscriptions, if any, that the message satisfies.

The term “published message,” as used herein, encompasses its ordinary and accustomed meaning in the relevant arts and includes, but is not limited to, any message intended by a publisher for any broadcast, forwarding or other distribution to, or ultimate reception and use by, a range and number of recipients, which may or may not be human, that are not recipients defined by the message or by its transmission.

The term “publisher,” as used herein, encompasses its ordinary and accustomed meaning in the relevant arts. Illustrative examples include, without limitation, news organizations, news-like organizations, financial reporting entities, and government reporting organizations, aggregators and web crawlers, and equivalents thereof, outputting messages having content useable for any subscription-based, content-determined forwarding.

The term “subscriber,” as used herein, encompasses, but is not limited to, its ordinary and accustomed meaning in the publish/subscribe arts and, in various embodiments, a subscriber may be a publisher or broker with respect to other subscribers.

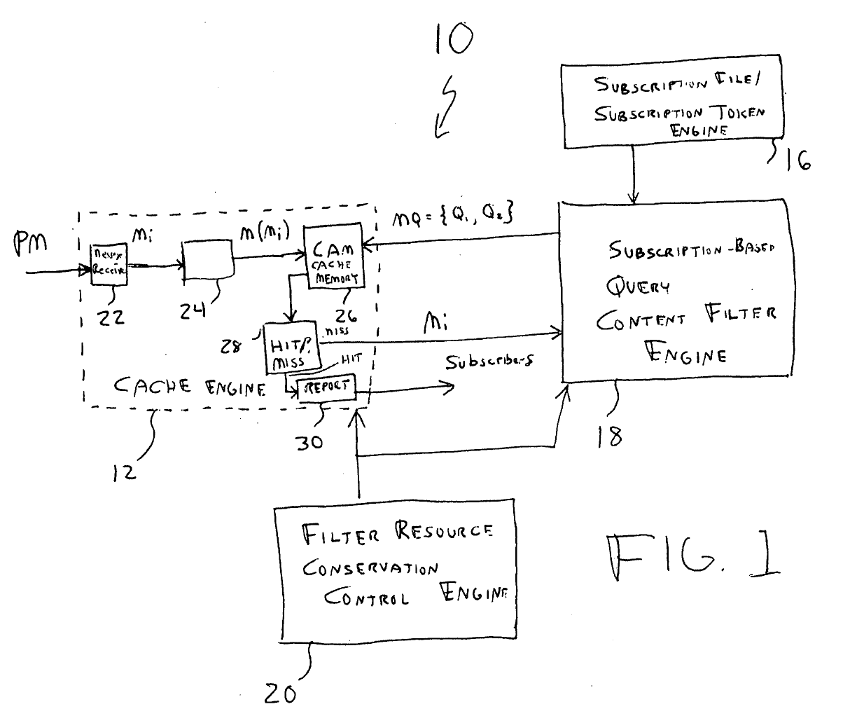

FIG. 1 illustrates one example of one system architecture 10 in accordance with various embodiments.

Referring to FIG. 1, the example architecture 10 is described according to various example engines, which is only one illustrative arrangement in terms of example engines, for purposes of describing various exemplary embodiment, and is are not a limitation of alternative and equivalent embodiments.

It will be understood that representation as engines, such as depicted in FIG. 1, is only one example representation of architectures according to the embodiments, and of the various embodiments that may be practiced on that example architecture. Persons of ordinary skill in the art, upon reading this description, will readily identify alternative arrangements of engines to represent equivalent and alternative architectures for practicing in accordance with the various embodiments including, but not limited to, subdividing various ones of the example depicted engines into a plurality of smaller or more limited engines, and combining two or more depicted example engines into a larger engine.

Further, it will be understood, by persons of ordinary skill in the art, upon reading this description, that the illustrative arrangement of engines may, or may not be representative of various hardware and/or hardware/software arrangements by which a person of ordinary skill in the art, based on the present disclosure, may implement and practice according to the embodiments

Referring to FIG. 1, example architecture 10 includes a cache engine 12, a subscription file/subscription token engine 16, a subscription-based query content filter engine 18, and a filter resource conserving controller 20, and example aspects, arrangements and implementations of each are described in further detail in sections below.

With continuing reference to FIG. 1, aspects of architecture 10 are described in reference to AML, but it will be understood that XML is only one illustrative example according to the various embodiments. Persons of ordinary skill in the relevant art will identify equivalent operations as would be performed using constraints of XML such as, for example, RSS and Extensible Hypertext Markup Language (XHTML) and alternative structured languages such as, for example, JavaScript Object Notation (JSON), and human readable data serialization (YAML).

With continuing reference to FIG. 1, example cache engine 12 comprises functions which may be represented as sub-engines, such as depicted as message receiving engine 22, a message identifier engine 24, a cache memory engine 26, a cache hit detector engine 28, and a subscription-based message reporting engine 30.

Referring to FIG. 1, in the example 10, message receiving engine 22 of cache engine 12 receives one or more externally generated messages, referenced generally in this description as PM and separately as PMᵢ, from publishers (not shown). It will be understood that messages PM received and processed according to various embodiments may be, but are not necessarily, in XML. The index i of the PMᵢ reference to publisher messages is an arbitrary index used in this description to reference different incidents of receiving PM messages at the architecture 10. Stated differently, PMᵢ and PMⱼ, where i≠j may be two different PM messages, received at separate times or concurrently, or may be two receptions of the same PM message such as, for example, one news release or from a given original source that is forwarded to the architecture 10 through two different paths, e.g., two different aggregators (not shown) prior to-be received at the cache engine 12.

Referring to FIG. 1, in the example architecture 10, message receiving engine 22 is preferably capable of receiving XML messages PMᵢ, converting each to a string Mᵢ, and inputting the string to the message identifier engine 24. The string Mᵢ may, but is not necessarily, formatted for subsequent processing as a Java object and, accordingly, may be configured conform to a Java string class.

Referring to FIG. 1, in the cache engine 12 of the example architecture 10 message identifier engine 24 assigns a message identifier MI(Mᵢ) to each message string M. The function MI may be, but is not necessarily, a hash function such as, for example, the Java function of “hashCode ( )”, configured to operate on the string Mᵢ.

With continuing reference to FIG. 1, in the example architecture 10, subscription file/subscription token engine 16 maintains based on, for example, given user queries, a plurality of given subscriptions, referenced generally in this description as SBS, and individually as SBSᵣ, r=1 to K. K is an arbitrary number representing the number of subscriptions. Subscription file/subscription token engine 16 may construct and maintain the subscriptions SBS according to the various methods of constructing and maintaining subscriptions that are known to persons skilled in the relevant arts, including the formatting of queries, and user interface(s) (not shown) for user-input and editing of queries. The queries, as understood by persons skilled in the relevant arts, define the information that the message PM must contain as the condition for receiving the message. Queries are referenced generally in this description as Q. Various kinds, types and classes of information that may be represented as queries Q, and therefore that may define subscriptions such as SBS, are well known in the art of publish/subscribe systems.

Referring to FIG. 1, subscription file/subscription token engine 16 preferably maintains, for each of the subscriptions SBS, an identity of a particular entity, referenced herein as a “subscriber,” interested in messages meeting the subscription's specification. It will be understood that a “subscriber” which may or may not be a person, and that subscriptions may overlap, i.e., multiple subscribers may be interested in the same message.

Referring to FIG. 1 example architecture 10, subscription-based content filter engine 18, referenced hereinafter as “content filter engine 18,” performs a content filter function, referenced in this description as FQ, on the message strings Mi that are input to the engine 18, to identify all subscriptions SBS the message string matches. The content filter function FQ therefore should embody all of the queries Q occurring in the universe of subscriptions SBS stored in the subscription file/subscription token engine 16. Content filter engine 18 may, for example, implement FQ as a plurality of one filters (not separately shown), for each of the queries Q. Content filter engine 18 may, for example, be constructed as a unified filter such as, or example, the XPath-based filter known in the XML content filtering or template filtering arts as “YFilter,” or equivalents thereof, embodying all the queries Q. Further to various XPath-based filter implementations, and referring to FIG. 1, in the example architecture 10, subscription file/subscription token engine 18 may be an XPath based engine and, accordingly, may receive queries Q from subscribers (not shown) and perform XPath parsing (not shown). In such example implementations, subscription file/subscription token engine 16 may generate subscription-associated XPath tokens, labeled generally as SubsToken, each SubsToken having associated subscriber information, labeled generally as SubsInfo. Such XPath tokens may be used by the various engines of the architecture 10 to define FQ and to configure content filter engine 18 to perform the FQ function.

With continuing reference to FIG. 1, in various embodiments content filter engine 18 may comprise a YFilter or equivalent non-deterministic automata filter and, in such various embodiments, content filter engine 18 may include a message parsing function (not separately shown in FIG. 1) such as, for example, Simple API for XML (SAX), or equivalent which, as known to persons skilled in the relevant arts, parses the message string Mᵢ into a sequence of node events (not shown), and which may construct a node tree (not shown), based on the sequence of node events to a form for input to the YFilter.

It will be understood that SAX and YFilter are only one illustrative example for the content filter engine 18 and its filter function FQ. Various alternatives will be apparent to persons of ordinary skill in the art upon reading this disclosure. For example, a Document Object Model (DOM) parser feeding an X-path based XFilter in one of various alternative embodiments, although DOM and XFilter have, as known to persons skilled in the relevant arts, certain deficiencies in comparison to SAX and YFilter, particularly with respect to streaming messages. Further, methods of selecting, implementing, and optimizing YFilters and SAX parsers, as well as XFilter and DOM parsers and equivalents, are well known in the relevant art and, therefore, further detailed description is not necessary and is omitted.

The computational burdens of performing YFilter, XFilter and alternative types of X-path based and equivalent content filtering are also well known in the relevant art. Therefore, the benefit of the described various embodiments in substantially reducing, if not eliminating, unnecessary incurring of such burden due to again filtering a duplicate of an earlier received message PM, to identify the same subscriptions SBS that were identified previously, will be readily understood by persons skilled in the art.

With continuing reference to FIG. 1, as understood by persons skilled in the art upon reading this disclosure, configuration and construction of the content filter engine 18 to embody a particular FQ may be performed by one or more of the subscription file/subscription token engine 16, content filter engine 18, and the controller 20. As further understood by persons of ordinary skill in the relevant art upon reading this disclosure, construction of FQ may but does not necessarily, include analyzing the universe of subscriptions SBS, to identify all multiple instances of the same query, and forming these into a single query, subscription token SubToken, or equivalent. A table (not separately shown), or an equivalent, may indicate all subscriptions SBS corresponding to each of the queries Q. The filter function FQ may, as such, embody an elemental set of queries, referenced generally as Q, with members individually labeled Qₛ, s=1 to S, where S represents the number of different queries. The queries Q may be, but are not necessarily, represented as XPath tokens, as is readily understood by a person of ordinary skill in the art upon reading this disclosure.

Referring to FIG. 1, the output filter function FQ be represented as FQ(Mᵢ)={MQ}, where MQ is a query match set (or a list or equivalent) that identifies each of the queries Q met by the message PMᵢ. A table or equivalent (not shown), as identified above, may map MQ to the corresponding subscriptions from among SBS such that the subscription-based content filter engine 18 outputs a match set Match(Mᵢ) identifying all of the subscriptions met-by the message PMᵢ.

Referring to FIG. 1, the content filter engine 18 may be configured to output, in instances where the query match set MQ={null set}, a value such as, for example, NO MATCH (not shown in FIG. 1) or equivalent. A cache HIT/MISS engine 28 may be included, to detect at least one of MQ being null or not null and NO MATCH being generated or not generated, to output a HIT or MISS, respectively. In the FIG. 1 example, the cache HIT/MISS engine outputs, in response to generating a MISS, the message string Mi to the subscription-based content filter engine 20. The example cache engine 20 may also include a cache hit reporting engine 30 that, in response to the cache HIT/MISS engine 28 indicating a HIT, transmits the cached search result MQ to the subscribers.

With continuing reference to FIG. 1, filter resource conservation control engine 20 controls the cache engine 12 to update the cache memory engine 24 by storing Match(Mᵢ) when FQ(Mᵢ) is not {null set}, in other words in instances where the content filter engine 18 filters a message Mᵢ and the filtering identifies that at least one of the queries Q (or tokens SubToken) is satisfied. The filter resource conservation control engine 20 engine stores Match(Mᵢ) in the cache memory engine 26 based on the message identifier MI(Mᵢ) of the Mᵢ message string such that Match(Mᵢ) may be subsequently read from the cache memory engine 26, by the filter resource conservation controller 20, based on a subsequently assigned, or calculated message identifier that this the same as the message identifier MI(Mᵢ) that was used to store Match(Mᵢ).

Referring to FIG. 1, one of various embodiments of the cache memory engine 26 may be, for example, a content-addressable memory (CAM) addressed by MI(Mᵢ). Various arrangements and implementations of CAM are known in the general data storage and processing arts, and are described in various readily available publications and, therefore, a further detailed description of CAMs is not necessary in this disclosure to enable persons of ordinary skill in the relevant arts, based on this disclosure, to practice the best mode of the various embodiments.

With continuing reference to FIG. 1, in the example 10, filter resource conservation controller engine 20 is operatively connected to the cache engine 12 and the content filter engine 18. In the example 10, included in the operative connections of the filter resource conservation controller engine 20 to the cache engine 12 is an operative connection (not separately shown in FIG. 1) to the message receiving engine 22, message identifier engine 24, and subscription report engine 24. As described in reference to various example operations described in further detail in sections below, the filter resource conservation controller engine 20 is configured to detect the cache engine 20 receiving (at, for example, its message receiving engine 22) messages PMᵢ and, in response, to control the message identifier engine 24 to receive the corresponding string Mᵢ (which may be identical to PMᵢ if PMᵢ is received as a string) and generate a message identifier MI(Mᵢ). The filter resource conservation controller 20, according to the various embodiments, accesses the cache memory engine 26 of the cache engine 12, using the message identifier MI(Mᵢ) to determine if cache engine 12 already has a valid Match(Mᵢ) value stored in associated with MI(Mᵢ).

One example implementation of the above-described accessing of the cache engine 12 to identify previously stored valid Match(Mᵢ) is to configure or construct the cache memory engine as a CAM, and configure the filter resource conservation controller 20 to address the CAM with the message identifier MI(Mᵢ). The HIT/MISS detecting engine 28 or, alternatively, the filter resource conservation controller 20 is configured to then detect if the resulting output of the cache engine 12 is a valid Match(Mᵢ) value. If the valid MatchN(Mᵢ) value is detected, i.e., if the HIT/MISS engine 28 detects a HIT, the filter resource conservation control engine, or the HIT/MISS engine 28, controls the subscription reporting engine 30 to perform a subscription notifying operation (not separately shown in the figures) based on the set of subscriptions SBS that are represented by the Match(Mᵢ) read from the cache engine 12.

It will be understood that the subscription notifying operation described hereinabove as performed in response to the filter conservation controller engine 20 detecting a CACHE HIT, e.g., forwarding the message to all of the subscribers corresponding to the subscriptions SBS represented by the valid Match(Mᵢ), is performed by the subscription reporting engine 30 without expending any resource of the content filter engine 18. The content filter engine 18 does not have to be employed because a valid Match(Mᵢ) establishes that, in fact, all subscriptions SBS met by the message Mᵢ were previously identified by the content filter engine 18 operating on a previous instance of the same message PMᵢ and stored in the cache engine 12.

Referring to FIG. 1, according to various embodiments, the cache engine 12 may be initialized, at least once, such that accessing the cache engine 12 with any message identifier MI(Mᵢ), within a given range of allowable values of the message identifier, will read out a Match(Mᵢ) value that the HIT/MISS detector engine 28, or equivalent, will detect as a MISS. After such an initialization, upon receiving the first message, PM₁, accessing the cache memory 26 using the hash code or other message identifier MI(M₁) will identify a MISS. As described in greater detail in sections below, in response to detecting the MISS corresponding to M₁ the filter resource conservation controller 20 controls the content filter engine 18 to filter the message string M₁ and, if the FQ(M₁) is not a null set, controls the cache engine 20 to store, in its cache memory engine 26, the Match(M₁) value representing all of the subscriptions satisfied by the message Mᵢ. As described hereinabove, the storing will be in accordance with the message M₁. If, on the other hand, FQ(M₁) of the first message string is a null set, i.e., none of the queries Q of the subscription SBS are satisfied, the filter resource conservation controller 20 will take no further action until the next message, i.e., PM₂ is received. This process will continue until a message PMᵢ is received that is duplicate of a previously received PM message, e.g., PM_{z}, which, when it was filtered by the content filter engine 18, produced a Match(M_{z}) that was not a null and, hence, was stored in the cache engine 12. When that instance occurs, the filter resource conservation controller 20 will control the cache engine 12, or its subscription report engine 30, to report the Match(M_{z}) message as, for example, described above.

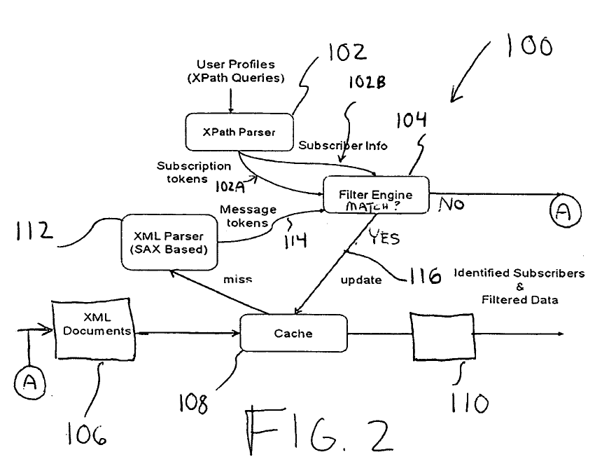

Turning now to FIG. 2, this shows an illustrative example functional flow of one example of one method 100 according to one or more embodiments. The FIG. 2 example flow 100 may be performed on, for example, an architecture according to the example 10 depicted at FIG. 1. References of example operations of the example flow 100 that identify engines of the architecture 10, however, are only for purposes of illustration, and do not limit the example 100 or other embodiments of the invention practiced on other architectures and environments.

Referring to FIG. 2, at 102 a plurality of User Profiles are received representing, for example, various queries Q as described in reference to FIG. 1, formatted, if required, into X-Path or equivalent queries to generate subscription tokens 102A and corresponding subscriber information 102B. Receiving the User Profiles at 102, and generating the subscription tokens 102A and subscriber information 102B may be performed on, for example, the subscription file/subscription token engine 16 of FIG. 1. Next, a filter engine 104 is constructed based on the subscription tokens and subscriber information. Construction of the filter engine may be performed on, for example, a combination of the subscription file/subscription token engine 16 and content filter engine 18 of FIG. 1 under control of, for example, the filter resource conservation controller 20 and may-produce for example, the content filter engine 18 having FQ of FIG. 1.

With continuing reference to FIG. 2, at 106 XML messages or documents PM are received and each message PMᵢ is input to a cache hit detecting step 108 to identify whether or not PMᵢ is a duplicate of an earlier PM message satisfying subscriptions defining the content filter 104. On an example processing environment having a content-addressable cache, or equivalent, an example of the cache hit detecting 108 is: a particular message PM₁ arrives, and is converted into a string representation M₁, and hash code K₁ is generated, where K₁=hash (M₁). The processing environment searches the cache using K₁ to locate a valid entry in the cache. If no entry for K₁ is found, it means that M₁ is arriving for the first time. Message M₁ is then parsed at 112, as shown in the FIG. 2 example, and as described in further detail below.

Cache hit detecting step 108 may be performed by cache engine 12 as described above, i.e., provide a cache engine such as item 12 of FIG. 1, generate a message identifier such as MI(Mᵢ) using, for example a hash code applied by, for example, the FIG. 1 message identifier engine 14, configure or construct a cache memory engine such as engine 26 of FIG. 1, and configure a filter resource conservation controller such as FIG. 1 item 20 to address the with the message identifier Ml(Mᵢ) and, depending on Match(Mᵢ), characterizing the event as a HIT or MISS.

Referring to FIG. 2, if the cache hit detecting 108 detects HIT, a subscription notifying operation 110 performs a reporting operation such as, for example, forwarding the message PMi or a representation or part of the message PMi to subscribers represented by subscriptions received at 102.

Referring to FIG. 2, if the cache hit detecting 108 detects MISS the message Mᵢ is parsed at 112, generating message tokens, labeled MTokens, e.g., a sequence of XML node events. The parsing 112 may be performed by, for example, a parsing function resident on, for example, the content filter engine 18 of FIG. 1 and may include example, Simple API for XML (SAX), or equivalent which, as known to persons skilled in the relevant arts.

With continuing reference to FIG. 2, after the parsing 112, the message tokens 114 are content filtered by the content filter constructed at 104 to detect a YES if any of the subscriptions represented by the 104 filter as met, and a NO if none of the subscriptions are met. The detection may, for example, be in accordance with the generation of FQ(Mᵢ)=MQᵢ described in reference to FIG. 1, with a YES generated if MQᵢ is not empty and a NO if MQᵢ is empty.

If the filtering at 114 detects NO match the example returns to 106 to wait for the next message, i.e., PMᵢ₊₁. If the answer at the filter 114 is YES, the example goes to 116 to update the cache used by the-cache hit detecting 108. The update 116 is performed by, for example, storing in the cache, the message PMᵢ or representation of PMᵢ, along with the result of the filtering 114. i.e., the subscriptions met by PMᵢ. The storing may, for example, include storing the message PMᵢ, or a hash or other code of its corresponding string MI(Mᵢ) as a pointer in a cache memory such as 26, along with and pointing to the match results MQᵢ. After the updating 116, the above-described subscription notifying operation 110 is performed by, for example, forwarding the message PMᵢ or a part of the message PMᵢ to subscribers identified by the filtering 114.

While certain embodiments and features of the invention have been illustrated and described herein, upon reading this disclosure many modifications, substitutions, changes, and equivalents will occur to those of ordinary skill in the art.

We hereby claim:

1. A publish/subscribe method for content-based distribution of messages generated by publishers, in accordance with given content-based filters based on given subscriptions based on given queries, comprising:
forming a cache of query match records, each record associated with a respective message, and recording each stored to be retrievable based on a coding of the message;
receiving a new message;
coding the new message to generate message identifier code;
identifying, based on accessing the cache with the message identifier code, whether the cache has a query match record for the new message; and
conditionally performing a content filtering operation, based on a result of said identifying, said conditionally performing including, if said identifying identifies the cache as having not having a subscription record for the new message, content filtering the message to generate query match data identifying queries, if any, satisfied by the message, else content filtering the message.

2. The method of claim 1, wherein said conditionally performing a content filtering operation further comprises conditionally updating the cache based on said generated query match data.

3. The method of claim 2, wherein said conditionally updating the cache includes, in response to the generated query match data identifying any query matches, retrievably storing a record of the query match data in the cache to be retrievable based on the message identifier of the message, else not storing a record of the query match data in the cache.

4. The method of claim 1, wherein said coding includes applying a coding function to the message, said coding function generating mutually identical message identifiers when applied to mutually identical duplicates of the same message, and respectively different message identifiers when applied to respectively different messages.

5. The method of claim 1, wherein said message is an XML message and wherein said content filtering includes parsing said XML message to generate a sequence of XML node events.

6. The method of claim 4, wherein said coding function is a hash function.

7. A publish/subscribe method for content-based distribution of messages in accordance with given content-based filters based on given subscriptions, comprising:
receiving an externally generated message having content meeting at least one given subscription;
calculating a message identifier for the message, based on applying a given calculation rule;
content filtering the message, the content filtering based on given subscriptions, to generate a subscription match set identifying each of the given subscriptions the message meets;
storing in a cache, in a manner retrievable based on the message's calculated message identifier, a valid subscription match record identifying the subscription set;
receiving a subsequent externally generated message;
calculating a subsequent message identifier for the subsequent message, based on applying the given calculation rule to the subsequent message;
accessing the cache, based on the subsequent message identifier, to retrieve an accessing result;
identifying whether the accessing result is a valid subscription match record and, in response to identifying the accessing result as not being a valid subscription match record, content filtering the subsequent message to generate a subsequent subscription match set identifying each of the given subscriptions the subsequent message meets and updating the cache based on the subsequent subscription match set; and, in response to the accessing identifying the valid subscription record.

8. A publish/subscribe method for content-based distribution of messages in accordance with given content-based filters based on subscriptions, comprising:
applying an identifier coding function to each of a plurality of message strings to generate a corresponding plurality of message identifier codes;
applying a subscription-based content filter, representing at least one given subscription, to the plurality of message strings to generate, for at least one of the messages, a subscription match set indentifying the subscriptions the message meets;
forming a subscription match result cache storing at least one of the subscription match sets as a subscription match record, the storing being retrievable based on the message identifier code of the string message that the subscription-based content filter filtered to generate the set;
receiving a new message;
applying the identifier coding function to the new message to generate a new message identifier code;
accessing the subscription match result cache based on the new message to identify whether the cache has a subscription match record for the new message code; and,
if the identifying identifies that the cache has a subscription match record for the new message, reporting the new message to subscribers identified by the match sets identified by the records and,
if the identifying identifies that the cache does not have a subscription match record for the new message, applying the subscription-based content filters to the new message and updating the cache based on a result of said applying.

9. A system for distributing externally generated messages based on given query-based subscriptions, comprising:
a content filter engine to filter messages input to the engine, to generate a match result set identifying which, if any, of a given set of subscriptions are met by the input message;
a match result cache engine to store match result sets generated by the subscription-based content filter engine, the cache engine having a message identifier code engine to calculate an identifier for the messages and the storing being retrievable from the cache using the message identifier code of the filtered message; and
a filter conservation control engine, operatively connected to the subscription-based content filter engine and the match result cache engine, to read the match result cache based on the message identifier of a received publish message to identify between a cache hit and a cache miss, the cache hit being the cache having a corresponding match result set and the cache hit being the cache not having a corresponding match result set and, in response to detecting a cache miss, controlling the subscription-based content filters to filter the message and, based on the subscription match set, if any, generated by the filtering, to update the cache to store the subscription match set to be retrievable based on the message identifier.

10. A system for content-based distribution of messages in accordance with given content-based filters based on subscriptions, comprising:
a message identifier engine to receive externally generated message strings and to generate, in response, message identifier codes having the same message identifier code in response to duplicate instances of the same message string, and respectively different message identifier codes in response to respectively different message strings;
a subscription-based content filter engine to filter message strings input to said engine and to generate a match result set identifying which, if any, of a given set of subscriptions are met by the messages;
a filter conservation control engine, having a cache to store match result sets generated by the subscription-based content filter engine, the storing being retrievable from the cache based on the message identifier code of the filtered message, to read the subscription match cache engine based on the message identifier of a received message string to identify if the cache has a corresponding match result set and, if the cache has a corresponding match result set, to transmit a subscription match report to the subscribers in accordance with the corresponding match result set and, if the cache does not have a corresponding match result set, controlling the subscription-based content filters to filter the message string and, based on the subscription match set, if any, generated by the filtering, to update the cache to store the subscription match.
